(19) United States
(12) Patent Application Publication
(10) Pub. No.: US 2015/0275766 A1
(43) Pub. Date: Oct. 1, 2015

(54) GEARED TURBINE ENGINE WITH A D-DUCT AND A THRUST REVERSER

(71) Applicant: United Technologies Corporation, Hartford, CT (US)

(72) Inventor: Gregory A. Kohlenberg, Kensington, CT (US)

(21) Appl. No.: 14/435,077

(22) PCT Filed: Oct. 10, 2013
(86) PCT No.: PCT/US2013/064351

§ 371 Date: Apr. 10, 2015

Related U.S. Application Data
(60) Provisional application No. 61/712,020, filed on Oct. 10, 2012.
(60) Provisional application No. 61/790,781, filed on Mar. 15, 2013.

(51) Int. Cl. F02C 7/36; F02K 1/06; F02C 3/04

(52) U.S. Cl. CPC F02C 7/36; F02C 3/04; F02K 1/06

(57) ABSTRACT

A geared turbine engine includes a first rotor, a second rotor, a gear train and an engine casing. The rotors and the gear train are arranged along an axial centerline. The gear train connects the first rotor to the second rotor. The casing extends circumferentially around the centerline and houses the first rotor, the second rotor and/or the gear train. The casing includes a casing door. The casing door includes a duct and a thrust reverser. The duct extends axially along and at least partially around the centerline.

This application claims priority to U.S. Provisional Appln. No. 61/712,020 filed Oct. 10, 2012 and U.S. Provisional Appln. No. 61/790,781 filed Mar. 15, 2013, which are hereby incorporated by reference.

### BACKGROUND OF THE INVENTION

1. Technical Field

This disclosure relates generally to a geared turbine engine and, more particularly, to a geared turbine engine with a thrust reverser.

2. Background Information

Various types and configurations of turbine engines and thrust reversers for turbine engines are known in the art. There is a need in the art, however, for an improved turbine engine and thrust reverser.

### SUMMARY OF THE DISCLOSURE

According to an aspect of the invention, a geared turbine engine is provided that includes a first rotor, a second rotor, a gear train and an engine casing. The first rotor, the second rotor and the gear train are arranged along an axial centerline, and the gear train connects the first rotor to the second rotor. The casing extends circumferentially around the centerline and houses the first rotor, the second rotor and/or the gear train. The casing includes a nozzle and a casing door. The casing door includes a duct and a thrust reverser. The duct extends axially along the centerline to the nozzle, and at least partially circumferentially around the centerline. The thrust reverser has an effective flow area that is greater than a throat exhaust area of the nozzle.

According to another aspect of the invention, a geared turbine engine is provided that includes an engine casing and a gear train that connects a first rotor to a second rotor along an axial centerline. The casing extends circumferentially around the first rotor, and includes a plurality of casing doors. At least one of the casing doors includes a D-duct and a thrust reverser.

According to still another aspect of the invention, a turbine engine system is provided that includes an engine support and a geared turbine engine. The engine includes an engine casing that extends circumferentially around an axial centerline. The engine casing includes a casing door that is pivotally connected to the engine support. The casing door includes a duct and a thrust reverser. The duct extends axially along and partially around the centerline.

The casing may include a nozzle. The duct (e.g., the D-duct) may extend axially along the centerline to the nozzle. The thrust reverser may have an effective flow area that is greater than a throat exhaust area of the nozzle.

The effective flow area may be greater than or equal to about one hundred and ten percent (110%) of the throat exhaust area, which may provide a high mass flow reversing system.

The engine may include a plurality of engine sections that provide forward thrust during a first mode of operation. A first of the engine sections (e.g., a turbine section) may include the first rotor. A second of the engine sections (e.g., a fan section or a compressor section) may include the second rotor. The thrust reverser may provide reverse thrust during a second mode of operation. The reverse thrust may be greater than or equal to about one fifth (e.g., 20%) of the forward thrust.

The engine may include a fan section, a compressor section, a combustor section and a turbine section. The fan section may include the first rotor; e.g., a fan rotor. The turbine section may include the second rotor; e.g., a turbine rotor. The compressor section may include a third rotor (e.g., a compressor rotor) that is connected to the second rotor through the gear train.

The engine may include a compressor section, a combustor section and a turbine section. The compressor section may include the first rotor; e.g., a compressor rotor. The turbine section may include the second rotor; e.g., a turbine rotor.

The gear train may be configured as an epicyclic transmission.

The engine casing may include a bypass flow path and a second casing door. The second casing door may include a second duct and a second thrust reverser. The second duct may extend axially along and partially around the centerline. The duct and the second duct may collectively define at least an axial portion of the bypass flow path.

The duct may have an arcuate or otherwise semi-annular cross-sectional geometry.

The duct may include an inner wall, an outer wall, and a plurality of side walls. The inner wall and the outer wall may extend circumferentially between the side walls. The side walls may extend radially between the inner wall and the outer wall.

The engine casing may include a core nacelle and a fan nacelle that extends circumferentially around the core nacelle. The inner wall may define a portion of the core nacelle, and the outer wall may define a portion of the fan nacelle.

The thrust reverser may include a plurality of turning vanes arranged, for example, in a cascade. The cascade may move axially within the casing door. One or more of the turning vanes may pivot within the casing door. Alternatively, the cascade may be fixed.

The thrust reverser may include a blocker door. The blocker door may pivot into a gas path of the engine to divert air into the thrust reverser. Alternatively, the thrust reverser may be configured as a blockerless door thrust reverser. The blockerless door thrust reverser may include, for example, a thrust reverser body and/or a cascade. The thrust reverser body may move axially to at least partially obstruct a gas path of the engine and divert air into the cascade.

The engine casing may include a variable area nozzle. The nozzle, for example, may be configured as or otherwise include one or more variable area nozzles. Each variable area nozzle may include a nozzle body, which may move axially and/or radially to change the throat exhaust area of the nozzle.

The geared turbine engine may include a gear train that connects a first rotor to a second rotor.

The engine casing may include a second casing door that is pivotally connected to the engine pylon. The second casing door may include a second duct and a second thrust reverser. The second duct may extend axially within the engine casing and partially around the centerline.

The engine casing may include a bypass flow path that extends axially within the engine casing. The duct and the second duct may define at least an axial portion of the bypass flow path.

The engine support may be an engine pylon, or an engine strut.

The foregoing features and the operation of the invention will become more apparent in light of the following description and the accompanying drawings.

### BRIEF DESCRIPTION OF THE DRAWINGS

FIG. 1 is a perspective illustration of a turbine engine system;

FIG. 2 is a partial sectional illustration of a geared turbine engine for the engine system of FIG. 1;

FIG. 3 a front view illustration of an engine casing for the engine system of FIG. 1 in an open configuration;

FIG. 4 is a sectional illustration of a thrust reverser and a variable area nozzle in a stowed configuration;

FIG. 5 is a sectional illustration of the thrust reverser in a stowed configuration and a variable area nozzle in a deployed configuration;

FIG. 6 is a sectional illustration of the thrust reverser and the variable area nozzle in a deployed configuration;

FIG. 7 is a sectional illustration of an alternative embodiment thrust reverser and variable area nozzle in a stowed configuration;

FIG. 8 is a sectional illustration of the thrust reverser and variable area nozzle of FIG. 7 in a deployed configuration;

FIG. 9 is a sectional illustration of another alternative embodiment thrust reverser in a stowed configuration;

FIG. 10 is a sectional illustration of the thrust reverser of FIG. 9 in a deployed configuration;

FIG. 11 is a cross-sectional illustration of a portion of the thrust reverser of FIGS. 9 and 10 pivoting between the stowed and the deployed configurations;

FIG. 12 is a sectional illustration of another alternative embodiment thrust reverser in a stowed configuration;

FIG. 13 is a sectional illustration of the thrust reverser of FIG. 12 in a deployed configuration;

FIG. 14 is a partial sectional illustration of an alternative embodiment geared turbine engine for the engine system of FIG. 1; and

FIG. 15 is a partial sectional illustration of another alternative embodiment geared turbine engine for the engine system of FIG. 1.

### DETAILED DESCRIPTION OF THE INVENTION

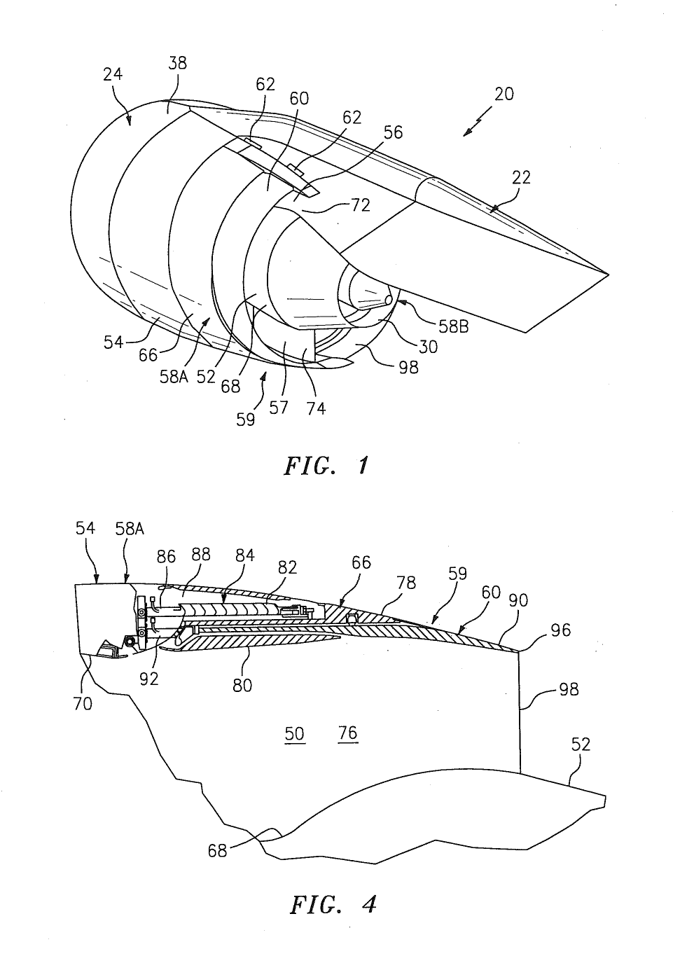

FIG. 1 is a perspective illustration of a turbine engine system 20 that includes an engine pylon 22 connected to a geared turbine engine 24 (e.g., geared turbofan engine). The pylon 22 is adapted to mount the engine 24 to an aircraft airframe such as, for example, an aircraft fuselage, an aircraft wing, etc.

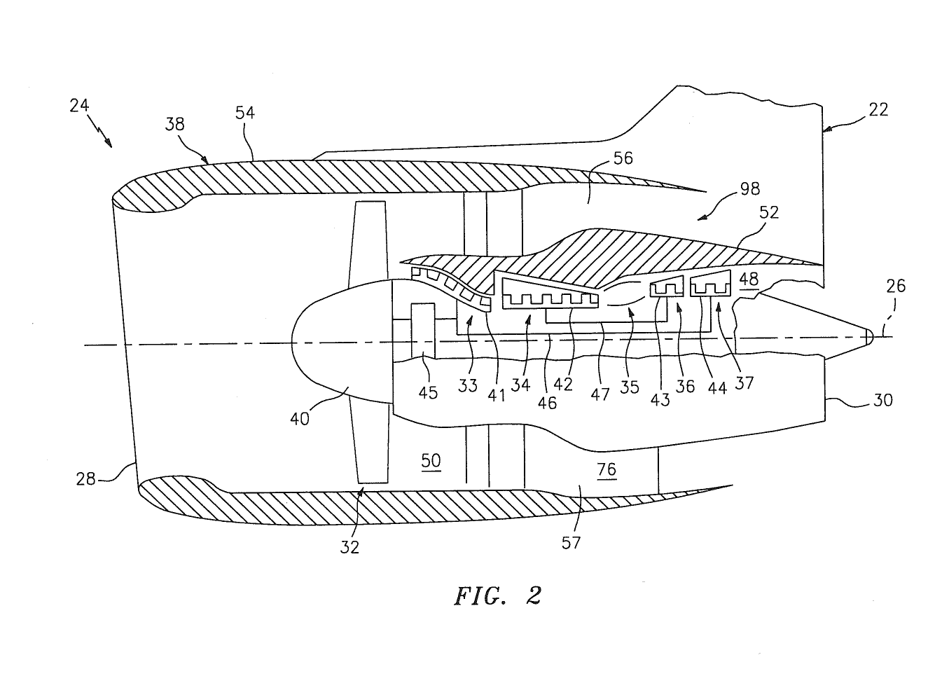

FIG. 2 is a partial sectional illustration of the engine 24 of FIG. 1. The engine 24 extends along an axial centerline 26 between a forward airflow inlet 28 and an aft airflow exhaust 30. The engine 24 includes a fan section 32, a low pressure compressor (LPC) section 33, a high pressure compressor (HPC) section 34, a combustor section 35, a high pressure turbine (HPT) section 36 and a low pressure turbine (LPT) section 37. The engine sections 32-37 are arranged sequentially along the centerline 26 and housed within an engine casing 38, which is described below in further detail. Each of the engine sections 32-34, 36 and 37 includes a respective rotor 40-44. Each of the rotors 40-44 includes a plurality of rotor blades arranged circumferentially around and connected (e.g., mechanically fastened, welded, brazed or otherwise adhered) to one or more respective rotor disks. The fan rotor 40 is connected to a gear train 45. The gear train 45 and the LPC rotor 41 are connected to and driven by the LPT rotor 44 through a low speed shaft 46. The HPC rotor 42 is connected to and driven by the HPT rotor 43 through a high speed shaft 47.

Air enters the engine 24 through the airflow inlet 28, and is directed through the fan section 32 and into an annular core gas path 48 and an annular bypass gas path 50. The air within the core gas path 48 may be referred to as “core air”. The air within the bypass gas path 50 may be referred to as “bypass air” or “cooling air”. The core air is directed through the engine sections 33-37 and exits the engine 24 through the airflow exhaust 30. Within the combustor section 35, fuel is injected into and mixed with the core air and ignited to provide engine forward thrust during a first mode of operation. The bypass air is directed through the bypass gas path 50 and out of the engine 24 to provide additional forward thrust during the first mode of operation, or engine reverse thrust during a second mode of operation. The reverse thrust may be equal to or greater than about one fifth (e.g., twenty percent) of the forward thrust. The bypass air may also be utilized to cool various turbine engine components within one or more of the engine sections 33-37 during the first and/or the second modes of operation. An example of the first mode of operation is where the engine 24 is being operated during takeoff and/or cruise. An example of the second mode of operation is where the engine 24 is being operated to reduce forward movement of the aircraft during landing.

Referring to FIGS. 1 and 2, the engine casing 38 extends axially between the airflow inlet 28 and the airflow exhaust 30, and circumferentially around the centerline 26. The engine casing 38 includes a core nacelle 52, a fan nacelle 54, and one or more bi-fi splitters 56 and 57 (i.e., bifurcations). The core nacelle 52 extends circumferentially around and houses the engine sections 33-37 and the gear train 45. The fan nacelle 54 extends circumferentially around and houses the fan section 32. The fan nacelle 54 also extends circumferentially around the core nacelle 52, which radially defines the bypass gas path 50 between the nacelles 52 and 54. The bi-fi splitters 56 and 57 extend radially between the core nacelle 52 and the fan nacelle 54. The bi-fi splitters 56 and 57 circumferentially bifurcate an aft axial portion of the bypass gas path 50.

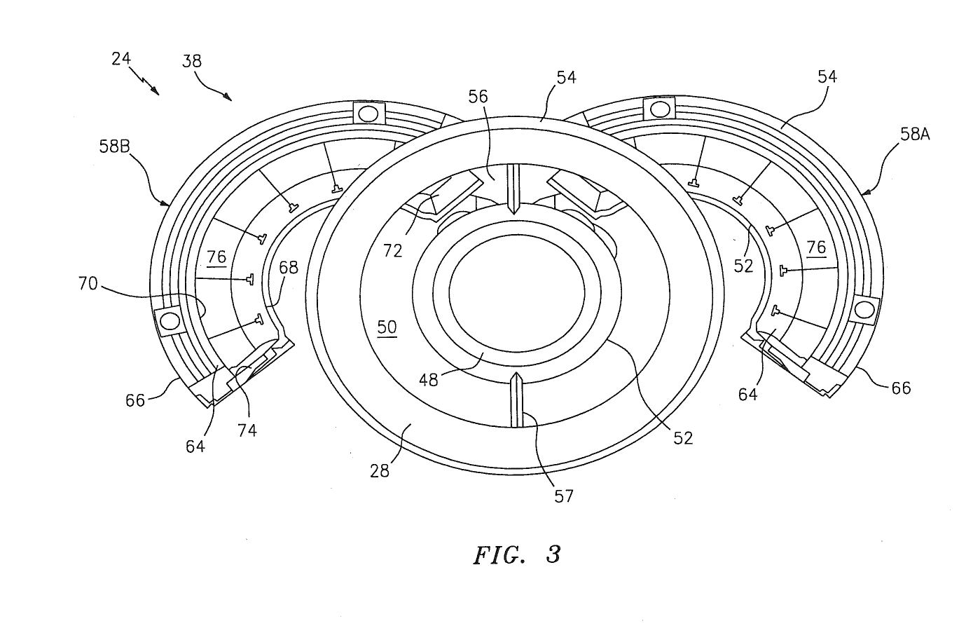

Referring to FIGS. 1 and 3, the engine casing 38 is configured with casing doors 58 A/B and a nozzle 59 (e.g., a bypass and/or fan nozzle), which may include respective variable area nozzles 60 (VANs); e.g., a variable area fan nozzles (VAFNs). The casing doors 58 A/B may be pivotally connected to an engine support with one or more respective hinges 62, where the engine support may be the pylon 22 or an engine strut that extends radially through the bi-fi splitter 56. The casing doors 58 A/B may be secured in a closed configuration as illustrated in FIG. 1 during, for example, turbine engine 24 operation. The casing doors 58 A/B may be independently pivoted to an open configuration as illustrated in FIG. 3 during, for example, turbine engine 24 maintenance. Referring again to FIGS. 1 and 3, each of the casing doors 58 A/B includes a D-duct 64 (also sometimes referred to as a “C-duct”) and a thrust reverser 66.

The D-duct 64 includes an inner wall 68, an outer wall 70, and a plurality of side walls 72 and 74. The inner wall 68 and the outer wall 70 each extends circumferentially between the side walls 72 and 74. The side walls 72 and 74 extend radially between the inner wall 68 and the outer wall 70. The inner wall 68 forms a radial outer portion of the core nacelle 52. The outer wall 70 forms a radial inner portion of the fan nacelle 54. The side wall 72 forms a side of the bi-fi splitter 56. The side wall 74 forms a side of the bi-fi splitter 57. The D-duct 64 therefore defines a circumferential portion 76 of the bifurcated bypass gas path 50 (see also FIG. 2).

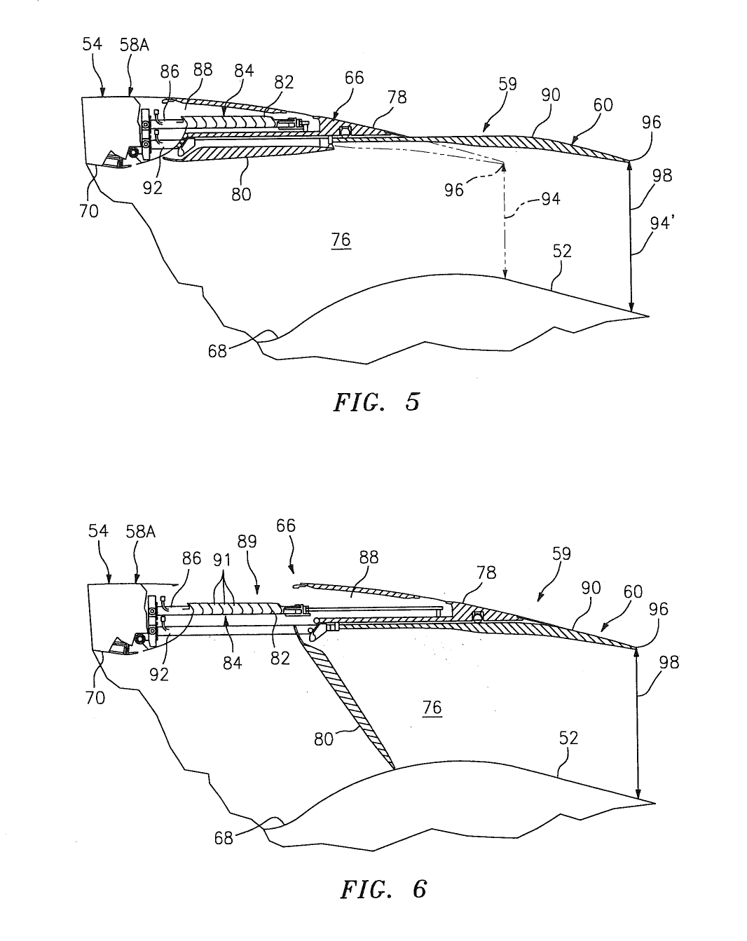

FIG. 4 is a sectional illustration of the thrust reverser 66 and the variable area nozzle 60 in a stowed configuration. FIG. 5 is a sectional illustration of the thrust reverser 66 in a stowed configuration and the variable area nozzle 60 in a deployed configuration. FIG. 6 is a sectional illustration of the thrust reverser 66 and the variable area nozzle 60 in a deployed configuration. Referring to FIGS. 4 to 6, the thrust reverser 66 includes a semi-annular thrust reverser body 78, thrust reverser blocker doors 80, thrust reverser turning vanes 82 arranged in a cascade 84, and respective thrust reverser actuators 86. The thrust reverser body 78 includes a recess 88 that houses the turning vanes 82 and the actuators 86 in the stowed configuration. The blocker doors 80 are pivotally connected to the thrust reverser body 78. One or more of the actuators 86 may include, but are not limited to, a valve, a hydraulic or pneumatic pump and/or piston, or an electric motor. The actuators 86 are adapted to move the thrust reverser body 78 axially between the stowed configuration of FIG. 4 and the deployed configuration of FIG. 6. As the thrust reverser body 78 moves axially, the blocker doors 80 may pivot radially inward into the circumferential portion 76 and divert at least some (or substantially all) of the bypass air through the cascade 84 to provide the reverse thrust.

Referring to FIG. 6, in the deployed configuration, the thrust reversers 66 have an effective flow area. The effective flow area describes a collective cross-sectional area of the flow paths 89 through the thrust reversers 66. For example, the effective flow area in the reverse thrust mode is equal to a collective cross-sectional area of the apertures 91 defined between the turning vanes 82 of the cascades 84. The effective flow area may also include the cross-sectional area of gaps through which air may bypass the blocker doors 80 and/or the cascades 84.

Referring to FIGS. 4 and 5, the VAFN 60 includes a semi-annular nozzle body 90 and one or more nozzle actuators 92. The nozzle body 90 is arranged radially within the thrust reverser body 78. The actuators 92 are adapted to move the nozzle body 90 axially between the stowed configuration of FIG. 4 and the deployed configuration of FIG. 5. As the nozzle body 90 moves axially aft, a radial height 94 between an aft end 96 of the fan nacelle 54 and the core nacelle 52 may change (e.g., increase) and thereby change (e.g., increase) a throat exhaust area of the aft bypass exhaust 98; e.g., the height 94′ may be greater than the height 94. The VAFN 60 therefore may adjust pressure drop across the bypass gas path 50 by changing the throat exhaust area of the aft bypass exhaust 98.

The throat exhaust area describes a cross-sectional area of the aft bypass exhaust 98. Referring to FIG. 6, the throat exhaust area may be less than or equal to the effective flow area of the thrust reversers 66. The effective flow area of the thrust reversers 66, for example, may be equal to or greater than about one hundred and ten percent (e.g., 110%) of the throat exhaust area of the aft bypass exhaust 98 where the thrust reversers 66 are in the stowed configuration. This relatively high effective flow area of the thrust reversers 66 is enabled by, for example, the relatively low fan pressure ratio of the engine 24, and provides a high mass flow reversing system.

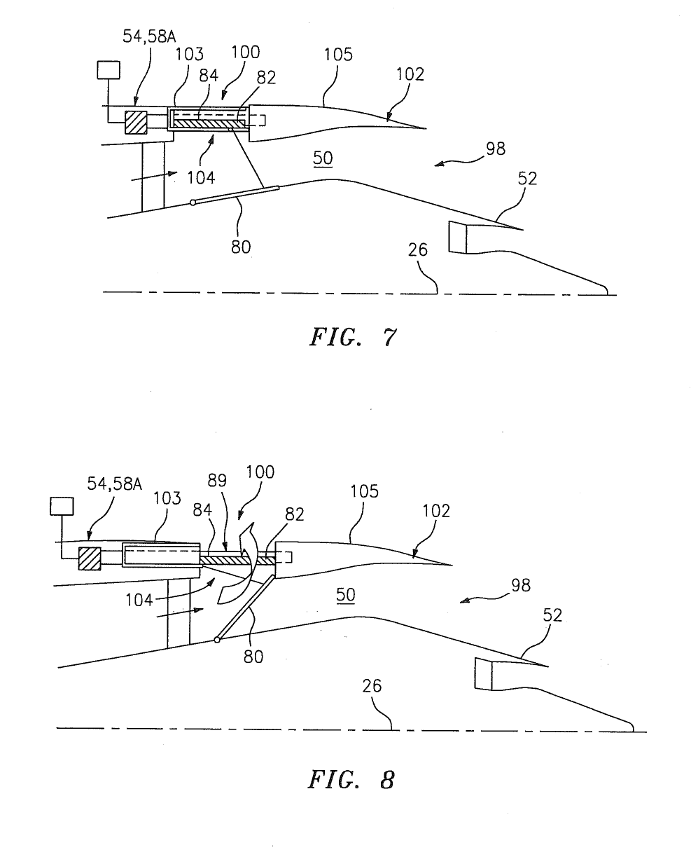

FIG. 7 is a sectional illustration of an alternative embodiment thrust reverser 100 and bypass VAFN 102 for the casing doors 58 A/B in a stowed configuration. FIG. 8 is a sectional illustration of the thrust reverser 100 and the VAFN 102 in a deployed configuration. In contrast to the thrust reverser 66 of FIGS. 4 to 6, the thrust reverser 100 includes a sleeve 103 and a duct 104 in which the cascade 84 is arranged and may be fixedly located. The sleeve 103 is adapted to move axially along the centerline 26 to close the duct 104 in the stowed configuration, and to open the duct 104 in the deployed configuration. The sleeve 103 is also connected to the blocker door 80, which is pivotally connected to the core nacelle 52. As the sleeve 103 moves axially to open the duct 104, the blocker door 80 pivots radially outward into the bypass gas path 50 and diverts at least some of the bypass air through the open duct 104 and the cascade 84. In this embodiment, an aft sleeve 105 of the casing doors 58 A/B may be configured to move independently and create the difference in height between 94 and 94′ (e.g., see FIG. 5). The present invention, however, is not limited to such a configuration.

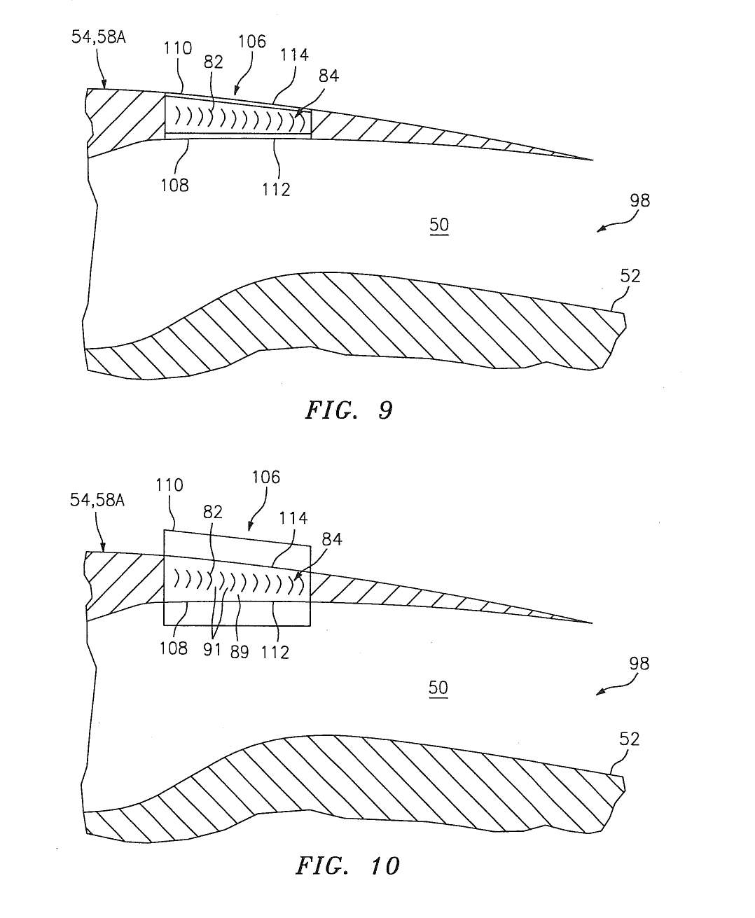

FIG. 9 is a sectional illustration of an alternative embodiment thrust reverser 106 for the casing doors 58 A/B in a stowed configuration. FIG. 10 is a sectional illustration of the thrust reverser 106 in a deployed configuration. FIG. 11 is a cross-sectional illustration of the thrust reverser 106 moving between the stowed and the deployed configurations. In contrast to the thrust reverser 66 of FIGS. 4 to 6, the thrust reverser 106 includes radial inner doors 108, radial outer doors 110, and the cascade 84 with the turning vanes 82. The doors 108 and 110 are pivotally connected to the casing door 58 A/B about respective longitudinal axes 112 and 114, which may be substantially parallel to the centerline 26. The inner doors 108 are adapted to pivot inwards into the bypass flow path 50. The outer doors 110 are adapted to pivot outwards.

The turning vanes 82 may be adapted to pivot about respective lateral axes that extend, for example, tangentially to the engine casing 38. In this manner, the turning vanes 82 may change the direction the diverted bypass gas exits the engine 24 in order to, for example, increase or decrease reverse thrust.

As illustrated in FIGS. 9 and 10, the engine casing 38 may be configured without a VAFN. The nozzle 59, for example, may be configured as a fixed nozzle. The engine casing 38 may be configured to bleed a quantity of the bypass gas through the thrust reverser 106 and/or another passage aperture in the casing doors 58 A/B to adjust the pressure drop across the bypass gas path 50. The other passage aperture may be a hole, a channel, a slot, etc.

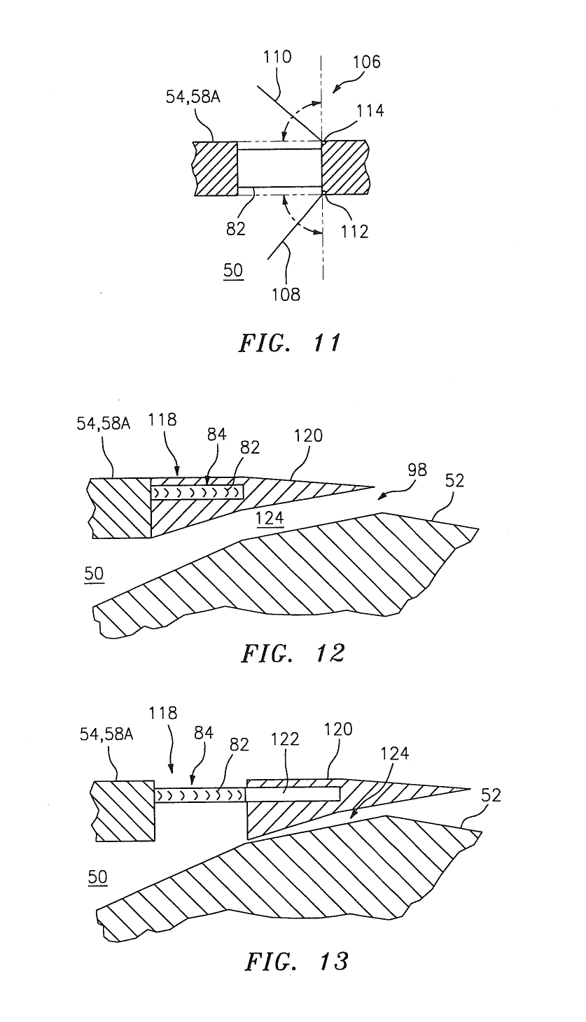

FIG. 12 is a sectional illustration of an alternative embodiment thrust reverser 118 for the casing door 58 A/B in a stowed configuration. FIG. 13 is a sectional illustration of the thrust reverser 118 in a deployed configuration. In contrast to the thrust reverser 66 of FIGS. 4 to 6, the thrust reverser 118 is configured as a blockerless door thrust reverser. The thrust reverser 118 includes a semi-annular thrust reverser body 120. The thrust reverser body 120 includes a recess 122 that houses the turning vanes 82 in the stowed configuration. The thrust reverser 118 includes one or more actuators (not shown) that are adapted to move the thrust reverser body 120 axially between the stowed configuration of FIG. 12 and the deployed configuration of FIG. 13. As the thrust reverser body 120 moves axially, the thrust reverser body 120 partially or fully obstructs an aft portion 124 of the bypass gas path 50, which diverts at least some (or substantially all) of the bypass air through the cascade 84 to provide the reverse thrust. In this embodiment, the cascade 84 is axially fixed. The thrust reverser 118 may or may not include fixed or translating turning vanes 82.

The engine casing 38 may include various thrust reverser and/or variable area nozzle types and configurations other than those described above and illustrated in the drawings. For example, other thrust reversers and/or variable area nozzles that may be included with the engine casing 38 are disclosed in U.S. Pat. Nos. 8,151,551; 8,127,529; 8,109,467; 8,104,262; 8,104,261; 8,006,479; 5,778,659 and 5,575,147, each of which is hereby incorporated herein by reference in its entirety. The present invention, however, is not limited to any particular thrust reverser and/or variable area nozzle types and/or configurations.

The gear train 45 may be configured as an epicyclic transmission such as, for example, a planetary gear system or a star gear system. An example of a planetary gear train is disclosed in U.S. Pat. No. 5,433,674, which is hereby incorporated herein by reference in its entirety. The present invention, however, is not limited to the application of any particular gear train.

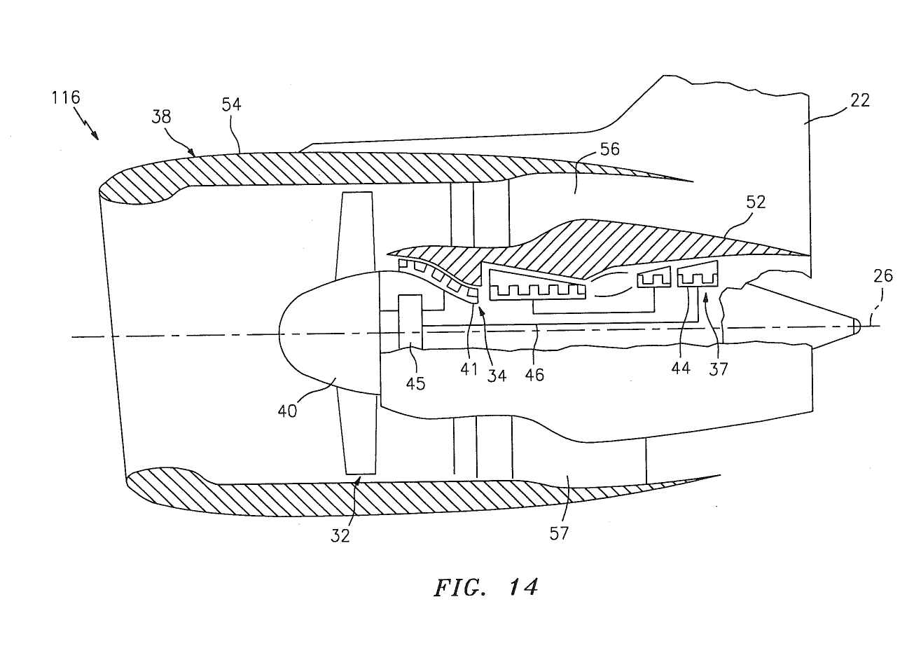

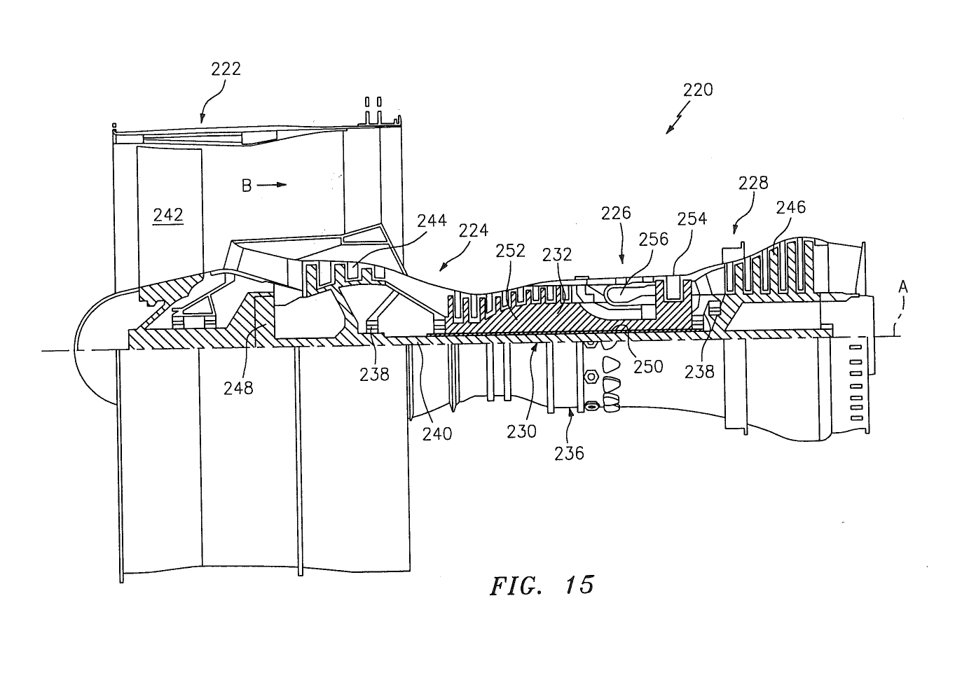

FIG. 14 is a partial sectional illustration of an alternate embodiment geared turbine engine 116 for the engine system 20 of FIG. 1. In contrast to the engine 24 of FIG. 2, the fan rotor 40 and the LPC rotor 41 of the engine 116 are connected to the gear train 45, which is connected to and driven by the LPT rotor 44 through the low speed shaft 46. The present invention, however, is not limited to any particular turbine engine configuration. For example, although the engines described above and illustrated in the drawings include a low speed spool (e.g., the rotors 40, 41 and 44 and the shaft 46) and a high speed spool (e.g., the rotors 42 and 43 and the shaft 47), the engine casing 38 may be configured for a geared turbine engine with a single spool (e.g., no high speed spool) or more than two spools (e.g., low, mid and high speed spools, etc.).

FIG. 15 is a partial sectional illustration of another alternate embodiment geared turbine engine 220 for the engine system 20 of FIG. 1. The turbine engine 220 is a two-spool turbofan that generally incorporates a fan section 222, a compressor section 224, a combustor section 226 and a turbine section 228. Alternative engines might include an augmentor section (not shown) among other systems or features. The fan section 222 drives air along a bypass flowpath while the compressor section 224 drives air along a core flowpath for compression and communication into the combustor section 226 then expansion through the turbine section 228. Although depicted as a turbofan gas turbine engine in the disclosed non-limiting embodiment, it should be understood that the concepts described herein are not limited to use with turbofans as the teachings may be applied to other types of turbine engines such as a three-spool (plus fan) engine wherein an intermediate spool includes an intermediate pressure compressor (IPC) between the LPC and HPC and an intermediate pressure turbine (IPT) between the HPT and LPT.

The engine 220 generally includes a low spool 230 and a high spool 232 mounted for rotation about an engine central longitudinal axis A relative to an engine static structure 236 via several bearing structures 238. The low spool 230 generally includes an inner shaft 240 that interconnects a fan 242, a low pressure compressor 244 (“LPC”) and a low pressure turbine 246 (“LPT”). The inner shaft 240 drives the fan 242 directly or through a geared architecture 248 to drive the fan 242 at a lower speed than the low spool 230. An exemplary reduction transmission is an epicyclic transmission, namely a planetary or star gear system as, for example, described above.

The high spool 232 includes an outer shaft 250 that interconnects a high pressure compressor 252 (“HPC”) and high pressure turbine 254 (“HPT”). A combustor 256 is arranged between the high pressure compressor 252 and the high pressure turbine 254. The inner shaft 240 and the outer shaft 250 are concentric and rotate about the engine central longitudinal axis A which is collinear with their longitudinal axes.

Core airflow is compressed by the low pressure compressor 244 then the high pressure compressor 252, mixed with the fuel and burned in the combustor 256, then expanded over the high pressure turbine 254 and low pressure turbine 246. The turbines 254, 246 rotationally drive the respective low spool 230 and high spool 232 in response to the expansion.

The main engine shafts 240, 250 are supported at a plurality of points by bearing structures 238 within the static structure 236. It should be understood that various bearing structures 238 at various locations may alternatively or additionally be provided.

In one non-limiting example, the gas turbine engine 220 is a high-bypass geared aircraft engine. In a further example, the gas turbine engine 220 bypass ratio is greater than about six (6:1). The geared architecture 248 can include an epicyclic gear train, such as a planetary gear system or other gear system. The example epicyclic gear train has a gear reduction ratio of greater than about 2.3:1, and in another example is greater than about 2.5:1. The geared turbofan enables operation of the low spool 230 at higher speeds which can increase the operational efficiency of the low pressure compressor 244 and low pressure turbine 246 and render increased pressure in a fewer number of stages.

A pressure ratio associated with the low pressure turbine 246 is pressure measured prior to the inlet of the low pressure turbine 246 as related to the pressure at the outlet of the low pressure turbine 246 prior to an exhaust nozzle of the gas turbine engine 220. In one non-limiting embodiment, the bypass ratio of the gas turbine engine 220 is greater than about ten (10:1), the fan diameter is significantly larger than that of the low pressure compressor 244, and the low pressure turbine 246 has a pressure ratio that is greater than about 5 (5:1). It should be understood, however, that the above parameters are only exemplary of one embodiment of a geared architecture engine and that the present disclosure is applicable to other gas turbine engines including direct drive turbofans.

In one embodiment, a significant amount of thrust is provided by the bypass flow path B due to the high bypass ratio. The fan section 222 of the gas turbine engine 220 is designed for a particular flight condition—typically cruise at about 0.8 Mach and about 35,000 feet. This flight condition, with the gas turbine engine 220 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 222 without the use of a Fan Exit Guide Vane system. The low Fan Pressure Ratio according to one non-limiting embodiment of the example gas turbine engine 220 is less than 1.45. Low Corrected Fan Tip Speed is the actual fan tip speed divided by an industry standard temperature correction of “T”/518.7^{0.5} in which “T” represents the ambient temperature in degrees Rankine. The Low Corrected Fan Tip Speed according to one non-limiting embodiment of the example gas turbine engine 220 is less than about 1150 fps (351 m/s).

The terms “upstream”, “downstream”, “inner” and “outer” are used to orientate the components of the engine casing 38 described above relative to the turbine engine and the centerline 26. A person of skill in the art will recognize, however, the engine casing 38 components may be utilized in other orientations than those described above. The present invention therefore is not limited to any particular spatial orientations.

While the drawings and description are directed towards one or a plurality of engine component(s), the disclosure and claims are not meant to be so limiting unless expressly indicated otherwise. The present invention may therefore be implemented with a greater and/or fewer number of such component(s), as the case may be.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined within any one of the aspects and remain within the scope of the invention. Accordingly, the present invention is not to be restricted except in light of the attached claims and their equivalents.

What is claimed is:

1. A geared turbine engine, comprising:
a first rotor, a second rotor and a gear train that are arranged along an axial centerline, wherein the gear train connects the first rotor to the second rotor; and
an engine casing extending circumferentially around the centerline and housing one or more of the first rotor, the second rotor and the gear train, the engine casing including a nozzle and a casing door that includes a duct and a thrust reverser;
wherein the duct extends axially along the centerline to the nozzle, and at least partially circumferentially around the centerline; and
wherein the thrust reverser has an effective flow area that is greater than a throat exhaust area of the nozzle.

2. The engine of claim 1, wherein the effective flow area is greater than or equal to about one hundred and ten percent of the throat exhaust area.

3. The engine of claim 1, further comprising:
a plurality of engine sections that provide forward thrust during a first mode of operation;
wherein a first of the engine sections includes the first rotor and a second of the engine sections includes the second rotor; and
wherein the thrust reverser provides reverse thrust, during a second mode of operation, that is greater than or equal to about one fifth of the forward thrust.

4. The engine of claim 1, further comprising:
a fan section, a compressor section, a combustor section and a turbine section;
wherein the fan section includes the first rotor and the turbine section includes the second rotor.

5. The engine of claim 4, wherein the compressor section includes a third rotor that is connected to the second rotor through the gear train.

6. The engine of claim 1, further comprising:
a compressor section, a combustor section and a turbine section;
wherein the compressor section includes the first rotor and the turbine section includes the second rotor.

7. The engine of claim 1, wherein the gear train comprises an epicyclic transmission.

8. The engine of claim 1, wherein
the engine casing further includes a bypass flow path and a second casing door;
the second casing door includes a second duct and a second thrust reverser;
the second duct extends axially along and partially around the centerline; and
the duct and the second duct collectively form at least an axial portion of the bypass flow path.

9. The engine of claim 1, wherein the duct has an arcuate cross-sectional geometry.

10. The engine of claim 1, wherein the duct includes an inner wall, an outer wall, and a plurality of side walls, the inner wall and the outer wall extend circumferentially between the side walls, and the side walls extend radially between the inner wall and the outer wall.

11. The engine of claim 10, wherein the engine casing further includes a core nacelle and a fan nacelle that extends circumferentially around the core nacelle, the inner wall defines a portion of the core nacelle, and the outer wall defines a portion of the fan nacelle.

12. The engine of claim 1, wherein the thrust reverser includes a plurality of turning vanes arranged within a fixed cascade.

13. The engine of claim 1, wherein the thrust reverser includes a plurality of turning vanes arranged within a cascade that moves axially within the casing door.

14. The engine of claim 1, wherein the thrust reverser includes a blocker door that pivots into a gas path to divert air into the thrust reverser.

15. The engine of claim 1, wherein
the thrust reverser comprises a blockerless door thrust reverser that includes a thrust reverser body and a cascade; and
the thrust reverser body moves axially to at least partially obstruct a gas path and divert air into the cascade.

16. The engine of claim 1, wherein
the nozzle includes a variable area nozzle that includes a nozzle body; and
the nozzle body moves at least one of axially or radially to change the throat exhaust area.

17. A geared turbine engine, comprising:
a gear train connecting a first rotor to a second rotor along an axial centerline; and
an engine casing extending circumferentially around the first rotor, and including a plurality of casing doors, at least one of the casing doors including a D-duct and a thrust reverser.

18. The engine of claim 1, wherein
the casing includes a nozzle;
the D-duct extends axially along the centerline to the nozzle; and
the thrust reverser has an effective flow area that is greater than or equal to about one hundred and ten percent of a throat exhaust area of the nozzle.

19. A turbine engine system, comprising:
an engine support; and
a geared turbine engine including an engine casing that extends circumferentially around an axial centerline, the engine casing including a casing door that is pivotally connected to the engine support, the casing door including a duct and a thrust reverser, the duct extending axially along and partially around the centerline.

20. The system of claim 19, wherein the engine support comprises an engine pylon.
